(19) United States
(12) Patent Application Publication
(10) Pub. No.: US 2020/0316913 A1
(43) Pub. Date: Oct. 8, 2020

(54) CROSS-LINKED POLYETHYLENE TUBING

(71) Applicants: William E. Hucks, Loris, SC (US); Avinash Laddha, Mumbai (IN)

(72) Inventors: William E. Hucks, Loris, SC (US); Avinash Laddha, Mumbai (IN)

(21) Appl. No.: 16/377,461

(22) Filed: Apr. 8, 2019

(51) Int. Cl. B32B 15/085; B32B 7/12; C08L 23/06; C08K 3/04; B32B 15/20

(52) U.S. Cl. CPC B32B 15/085; B32B 7/12; C08L 23/06; C08L 2312/00; B32B 15/20; C08L 2203/18; B32B 2597/00; C08K 3/04

(57) ABSTRACT

A cross-linked polyethylene (PEX) tubing having an aluminum welded tube as reinforcement and method of making PEX tubing disclose tubing having an inner PEX layer and an outer polyethylene layer with an intermediate aluminum tube enveloped by adhesive layers for joining the inner and outer polyethylene layers with the aluminum tube. Carbon black particles are included in the polyethylene material for increasing absorption and dispersion of UV and thermal energy.

### FIELD OF THE INVENTION

This invention relates to cross-linked polyethylene (PEX) inner layer tubing having a welded aluminum tube as a reinforcement center and an energy absorbing outer polyethylene layer.

### BACKGROUND OF THE INVENTION

Many cross-linked polyethylene (PEX) materials for conduit, pipe, and/or tubing have been proposed and offered, usually having a specific structure and/or utility. For example, PEX material having corrosive resistance properties have been utilized and incorporated into the manufacture of PEX for end-use as tubing in a variety of fluid-carrying systems, including water transport. Other properties, such as relative rigidity or flexibility, have been utilized and incorporated into such manufactures of PEX-type tubing. However, several desirable properties have not been utilized.

Accordingly, there is an unresolved need to provide improved cross-linked polyethylene (PEX) tubing.

### SUMMARY OF THE INVENTION

Example embodiments provide cross-linked polyethylene (PEX) composite tubing comprising an inner PEX layer and an outer polyethylene (PE) layer; an intermediate aluminum tube; and an inner adhesive layer and an outer adhesive layer, wherein the adhesive layers enveloping the intermediate aluminum tube.

In one embodiment, the intermediate aluminum tube comprises soft aluminum strips.

In another embodiment, the outer polyethylene layer comprises carbon black particles dispersed therewith. In another embodiment, the carbon black particles comprise approximately 20% by weight of the total weight of the outer polyethylene (PE) layer.

A method of making cross-linked polyethylene (PEX) tubing having a welded aluminum tube as a reinforcing layer comprising the steps of: forming an inner PEX layer from cross-linked polyethylene material with required catalyst; forming an intermediate welded aluminum tube from soft aluminum strips; forming an forming an inner adhesive layer and an outer adhesive layer from grafted linear low density polyethylene; enveloping the intermediate aluminum tube with the inner adhesive layer and the outer adhesive layer; forming an outer polyethylene layer from polyethylene material; joining the inner adhesive layer and the inner PEX layer; and joining the outer adhesive layer and the outer polyethylene layer.

The method may further comprise the step of: adding carbon black particles to the cross-linked polyethylene material.

The method may further comprise the step of: adding 2%±0.50% carbon black particles to the cross-linked polyethylene material used in forming the inner cross-linked polyethylene layer.

The method may further comprise the step of: adding approximately 20%±1.0% by weight of carbon black particles to the polyethylene material used in forming the outer polyethylene layer.

### BRIEF DESCRIPTION OF THE DRAWINGS

FIG. 1 illustrates a sectional view of cross-linked polyethylene tubing having an aluminum tube as a reinforcing layer.

### DESCRIPTION OF THE EMBODIMENT(S)

It will be readily understood that the components of the present invention, as generally described and illustrated in the figures herein, may be arranged and designed in a wide variety of different configurations.

Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

As generally depicted in the figures, pipe, conduit, or tubing may be manufactured from polyethylene (PE) in combination with composite material and carbon black. Ethylene monomer is polymerized to manufacture polyethylene, which is then cross-linked at a selected stage to change the structure from a thermoplastic (moldable) to a thermoset (rigid), thereby increasing high temperature properties, chemical resistance, and permanent physical deformity.

In particular, the cross-linked polyethylene (PEX) composite tubing 10 described herein includes an inner PEX layer 12, an outer polyethylene layer 20, an intermediate aluminum tube 16, and inner 14 and outer 18 adhesive layers enveloping the intermediate aluminum tube 16.

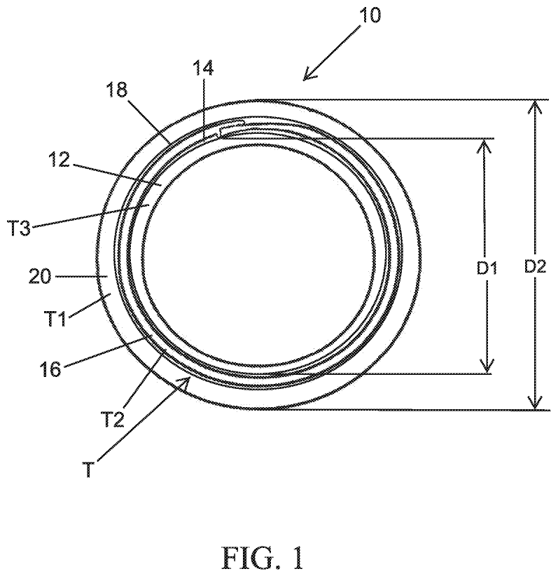

In one embodiment, consistent with FIG. 1, the combined total thickness (T) of the inner PEX layer 12, the outer polyethylene layer 20, the intermediate adhesive layers 14, 18, and aluminum tube 16, defining a wall, is envisioned to range from approximately 3.15 mm to 3.60 mm. A minimum thickness value for the outer polyethylene layer 20 thickness (T1) is envisioned to be at least 0.50 mm. A thickness (T2) for the aluminum tube 16 is envisioned to have a value of approximately 0.19 mm±0.02 mm. A value for the inner PEX layer 12 thickness (T3) is envisioned to range between 2.45 mm and 2.75 mm. Overall, the outside diameter (D2) of tubing 10 is envisioned as approximately 24 mm±0.15 mm, with an outside diameter (D1) for the inner PEX layer 12 comprising approximately 22.35 mm±0.15 mm.

The inner 14 and outer 18 adhesive layers may be manufactured from grafted low-density polyethylene (LLDPE). The LLDPE interacts with the PEX-material of the inner layer 12 and the outer layer 20 to form multiple layers of tubing 10. The adhesive layers 14 and 18 are formed to create an envelope surrounding the aluminum tube 16 and to join the inner PEX layer 12 to the inner adhesive layer 14 and join the outer polyethylene layer 20 to the outer adhesive layer 18. It is envisioned that the aluminum tube 16 comprises soft aluminum strips that provides additional mechanical strength to the tubing 10 structure.

It is envisioned that the tubing 10 may be manufactured by the addition of carbon black to the PEX-material used for extruding the inner and outer layers 12 and 20. In particular, one embodiment includes the production of a PEX-material composition having a pre-defined percentage of fine particles of carbon black material dispersed through the PEX-material product. More particularly, a pre-determined percentage by weight of carbon black material is added to a pre-determined percentage by weight of PEX-material to manufacture a master batch blend for use in the inner layer 12 and/or outer layer 20 of tubing 10. In one particular embodiment, the carbon black material is added (by a pre-determined percentage by weight) to the PEX-material for manufacture of the outer layer 20, thereby dispersing the carbon black particles throughout the outer layer 20 and providing a means for dissipating thermal energy through the tubing 10 via the carbon black particles. It is envisioned that the outer layer 20 PEX-material infused with carbon black particles will operate as a screen and also absorb ultraviolet (UV) radiation that is transformed into thermal energy dissipated throughout the tubing 10.

In one embodiment, the carbon black material comprises approximately 20% (by weight) of the outer layer 20 of PEX-material. At approximately 20% (by weight), the PEX-material infused with carbon black particles optimizes temperature absorption, including any energy converted from UV or other energy absorbed by the tubing 10.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A cross-linked polyethylene (PEX) composite tubing comprising:
an inner PEX layer and an outer polyethylene layer;
an intermediate aluminum tube; and
an inner adhesive layer and an outer adhesive layer, the adhesive layers enveloping the intermediate aluminum tube.

2. The composite tubing of claim 1, wherein the total thickness of the tubing traversing the inner PEX layer and the outer polyethylene layer comprises a range of 3.15 mm to 3.60 mm.

3. The composite tubing of claim 2, wherein the outer polyethylene layer comprises a thickness of at least 0.50 mm.

4. The composite tubing of claim 2, wherein the aluminum tube comprises a thickness of 0.19 mm±0.02 mm.

5. The composite tubing of claim 2, wherein inner PEX layer comprises a thickness in a range of 2.45 mm and 2.75 mm.

6. The composite tubing of claim 2, wherein the outside diameter of the tubing comprises a distance of 24 mm±0.15 mm.

7. The composite tubing of claim 1, wherein the intermediate aluminum tube comprises soft aluminum strips.

8. The composite tubing of claim 1, wherein the outer polyethylene layer comprises carbon black particles dispersed therewith.

9. The composite tubing of claim 8, wherein the carbon black particles comprises approximately 20% by weight of the total weight of the outer polyethylene layer.

10. A method of making cross-linked polyethylene (PEX) tubing comprising the steps of:
forming an inner PEX layer from polyethylene material;
forming an intermediate aluminum tube from soft aluminum strips;
forming an forming an inner adhesive layer and an outer adhesive layer from grafted low density polyethylene;
enveloping the intermediate aluminum tube with the inner adhesive layer and the outer adhesive layer;
forming an outer polyethylene layer from polyethylene material;
joining the inner adhesive layer and the inner PEX layer; and
joining the outer adhesive layer and the outer polyethylene layer.

11. The method of claim 10 further comprising the step of: adding carbon black particles to the polyethylene material.

12. The method of claim 10 further comprising the step of: adding carbon black particles to the polyethylene material used in forming the outer polyethylene layer.

13. The method of claim 10 further comprising the step of: adding approximately 20% by weight of carbon black particles to the polyethylene material used in forming the outer polyethylene layer.
